(19) United States
(12) Patent Application Publication
(10) Pub. No.: US 2015/0154880 A1
(43) Pub. Date: Jun. 4, 2015

(54) HEALTHCARE MANAGEMENT WITH A SUPPORT NETWORK

(71) Applicant: Aetna Inc., Hartford, CT (US)

(72) Inventors: John William Petito, Jersey City, NJ (US); Jeff Jacques, New York, NY (US); Kimberly Irene Paul, Jersey City, NJ (US)

(73) Assignee: Aetna Inc., Hartford, CT (US)

(21) Appl. No.: 14/094,069

(22) Filed: Dec. 2, 2013

(51) Int. Cl. G09B 19/00; G06F 19/00

(52) U.S. Cl. CPC G09B 19/00; G06F 19/3481

(57) ABSTRACT

Systems and methods for supporting the care of a patient are disclosed. Embodiments of the disclosure provide systems and methods for supporting the care of a patient through the use of a patient's support network. The patient can be in any stage of the healthcare system, including being an in-patient at a hospital or other facility or receiving out-patient care. The support network comprises friends, family members and others that have an interest in supporting the patient. The system includes providing at least one member of the support network access to healthcare professionals through a support computing device.

### FIELD

This disclosure relates generally to the field of health care management and, more particularly, to systems and methods for patient care support for patients with a support network.

### BACKGROUND OF THE INVENTION

A typical healthcare system includes a number of participants, such as patients, doctors, hospitals and insurance carriers. Many patients have a support network made up of numerous individuals. For example, a patient's support network could comprise parents, siblings, extended family members and friends. While a typical healthcare system integrates the patients, doctors, hospitals and insurance carriers, individuals in the support network are not fully integrated and included in the care of the patient. Including a patient's support network in the patient care process leads to both better health outcomes and lower costs for the healthcare system.

By way of example, a growing number of infants are born prematurely and many of those infants are cared for in a neonatal intensive care unit (NICU). Those infants typically have a support network made up of at least one or both parents. By some estimates, 12.5% of all infants born in the United States are born preterm. Further, the incidence of prematurity is on the rise. The number of babies born pre-term in the United States has risen 30% since 1981. The nearly 500,000 premature births per year costs the US healthcare system more than $26 billion.

Parents with an infant in a NICU face numerous challenges. For example, parents often experience fear and isolation. Further, parents dwell on pre-NICU expectations of a healthy baby. Many parents feel that the NICU is a “black box” where time is suspended. The healthcare system fails to provide a clear role for parents. Further, parents are physically separated from their baby, which is emotionally difficult. Additionally, many parents have a limited understanding of medical care procedures and the NICU generally. This limited understanding increases many of the challenges.

Even after the infant is discharged from the NICU and hospital, parents face many challenges. For example, care coordination for premature babies is complex. There is limited access and availability of premature baby specialized primary care physicians and pediatricians. Locating ancillary care specialists, such as physical therapists and occupational therapists is difficult. Parents of premature infants are more likely to take them to the emergency room and seem to have a reduced, fear based threshold for doing so. Additionally, parents often lack a social support network.

Accordingly, there remains a need in the art for systems and methods for patient care support for patients with a support network.

### BRIEF SUMMARY OF THE INVENTION

Some embodiments of the disclosure provide methods for supporting the care of a prematurely born infant. The infant has a support network with at least one parent in the support network. The method includes identifying the infant's care needs and goals for the parent by conducting an initial intake assessment process with the parent. A support management processor generates a personalized support program for the infant based on the identified care needs and goals for the parent. The personalized support program includes educational material and support messages for the parent. The support management processor delivers the educational material and support messages to the parent via a network connected support computing device. The support management processor may track whether the parent completes the goals, views the educational material and views support messages on the support computing device; The support management processor may create a support community of similarly situated individuals to the parent. The support community is accessible via the support computing device. The support management processor receives care data related to the infant from the parent. The support management processor then processes the care data to identify at least one care management trigger. Based on the care management trigger, the support management processor alerts a healthcare professional to perform an outreach to the parent.

Other embodiments of the disclosure provide methods for supporting the care of a patient. The patient has a support network with at least one support person in the support network. The method includes identifying the patient's care needs and goals for the support person by conducting an initial intake process. A support management processor a personalized support program for the patient based on the identified care needs and goals for the support person. The personalized support program includes educational material and support messages for the support person. The support management processor delivers the educational material and support messages to the support person via a network connected support computing device. The support management processor may track whether the support person completes the goals, views the educational material and views support messages on the support computing device. The support management processor can create a support community. The support community is accessible via the support computing device. The support management processor receives care data related to the patient from the support person. The support management processor then processes the care data to identify at least one care management trigger. Based on the care management trigger, the support management processor alerts a healthcare professional to perform an outreach to the support person.

Other embodiments provide a non-transitory computer readable medium having stored thereon computer executable instructions for supporting the care of a patient. The medium includes instructions for generating a personalized support program for the patient based on identified care needs and goals for the support person. The personalized support program includes educational material and support messages for the support person. Instructions for delivering the educational material and support messages to the support person via a network connected support computing device. Instructions for tracking whether the support person completes the goals, views the educational material and views support messages on the support computing device. Instructions for creating a support community of similarly situated individuals to the support person, wherein the support community is accessible via the support computing device. Instructions for receiving care data related to the patient from the support person. Instructions for processing the care data to identify at least one care management trigger and instructions for alerting, based on the care management trigger, a healthcare professional to perform an outreach to the support person.

### BRIEF DESCRIPTION OF THE SEVERAL VIEWS OF THE DRAWING(S)

FIG. 1 is a diagram of a system for supporting the care of a patient having a support network according to one embodiment.

FIG. 2 is a diagram of a system for enabling video conferencing between a healthcare professional and a patient support person according to one embodiment.

FIG. 3 is a diagram of a system for enabling text chatting between a healthcare professional and a patient support person according to one embodiment.

FIG. 4 is a diagram of a system for enabling a calendar entry to be made on a support computing device according to one embodiment.

FIG. 5 illustrates a user interface screen for managing material for a patient support person according to one embodiment.

FIG. 6 illustrates a user interface screen for managing support people for a patient according to one embodiment.

FIG. 7 illustrates a user interface screen for performing a text chat with a patient support person according to one embodiment.

FIG. 8 illustrates a user interface screen for performing a video conference with a patient support person according to one embodiment.

FIG. 9 illustrates a user interface screen for entering patient information according to one embodiment.

FIG. 10 illustrates a user interface screen including patient information and patient tracking information according to one embodiment.

FIG. 11 illustrates a user interface screen for managing material for a patient support person according to one embodiment.

FIG. 12 illustrates a user interface screen for navigating a support computing device according to one embodiment.

FIG. 13 illustrates a user interface screen for performing a text chat, on a support computing device, with a healthcare professional according to one embodiment.

FIG. 14 illustrates a user interface screen for performing a video conference, on a support computing device, with a healthcare professional according to one embodiment.

FIG. 15 illustrates a user interface screen for sending electronic mail, on a support computing device, to a healthcare professional according to one embodiment.

FIG. 16 illustrates a user interface screen for reviewing material on a support computing device according to one embodiment.

FIG. 17 illustrates a user interface screen for viewing patient tracking information on a support computing device according to one embodiment.

FIG. 18 illustrates a user interface screen for connecting with a support community on a support computing device according to one embodiment.

FIG. 19 illustrates a user interface screen for entering journal information on a support computing device according to one embodiment.

FIG. 20 illustrates a user interface screen for reviewing material on a support computing device according to one embodiment.

FIG. 21 is a flow chart illustrating a method for supporting the care of a patient in accordance with one embodiment.

FIG. 22 is a schematic diagram showing hardware components of a support management computer system according to one embodiment.

### DETAILED DESCRIPTION OF THE INVENTION

Embodiments of the disclosure provide systems and methods for supporting the care of a patient through the use of a patient's support network. The patient can be in any stage of the healthcare system, including being an in-patient at a hospital or other facility or receiving out-patient care. The support network comprises friends, family members and others that have an interest in supporting the patient. The system includes providing at least one member of the support network access to healthcare professionals through a support computing device. In some embodiments, the support person actively engages in the care of the patient by setting goals for the patient, reviewing material relating to the patient or conditions the patient has, text chatting and video conferencing with a health care professional. Some embodiments the patient is a prematurely born infant in a neonatal intensive care unit (NICU). The infant's parents then act as the support network. Other embodiments include other types of patients and support networks.

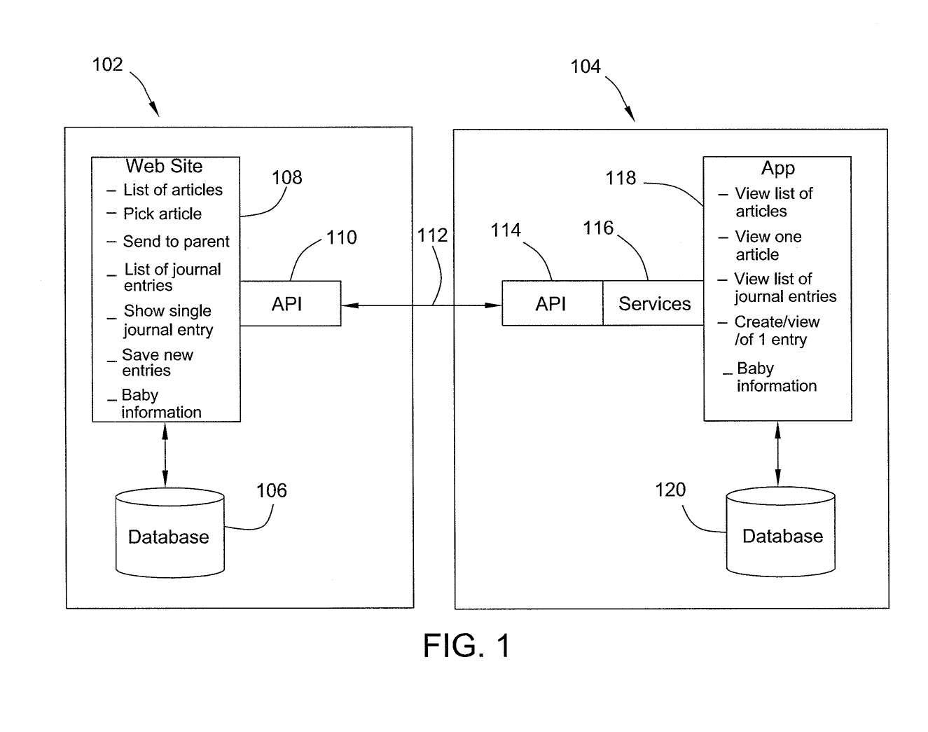

Turning to FIG. 1, a diagram of a system for supporting the care of a patient having a support network according to one embodiment is shown. A support management computer system 102 and a support computing device 104 are shown. The support management computer system 102 includes a database containing information relating to patients, including support networks for the patients. In one embodiment, a healthcare professional interacts with the support management computer system 102 through a website 108. However, in alternative embodiments the healthcare professional interacts with the support management computer system 102 through other means, such as a stand-alone application on a computer or a mobile application. As explained in more detail below, the support management computer system 102 includes information such as a list of articles or other educational information that can be sent to the support computing device 104. In one embodiment, a health care professional can view a listing of articles, pick an article relevant to a particular infant in the NICU and send the article to the infant's parents' support computing device 104. Similarly, through the website 108, the healthcare professional can view a list of journal entries made by the parents and select a single journal entry to view its details. Through website 108, the healthcare professional can also view information relating to the infant, such as weight and feedings. Additional functions and components of the support management computer system 102 are described below.

The support management computer system 102 interfaces with the support computing device 104 using and application programming interface (API) 110 and link 112. Link 112 can be any network connection including a wired connection over a local area network, a combination of wired and wireless connections over wide area network or any combination. In one embodiment, the support computing device 104 is a tablet computer connected to the internet using a wireless connection. In some embodiments the support computing device 104 and the support management computer system 102 encrypt communication over link 112 to improve security and protect patient privacy.

Support computing device 104 can be any appropriate computing device including a desktop computer, laptop computer, tablet computer or mobile device such as a mobile telephone. In one embodiment, the support computing device 104 includes an API 114 to communicate with the support management computer system 102. In this embodiment an application is used to access support resources. The support computing device 104 can access resources using various means. In some embodiments, the support computing device access the resources using a website. Using an application allows for the synchronization of data so that it can be viewed later without a network connection. The API 114 connects to various services 116. Example services include an article service, journal service and infant information service. The services 116 connect to the application 118, which connects to a database 120. As described in more detail below, the application 118 provides a user interface for viewing a listing articles of articles, viewing a single article, viewing a listing of journal entries, creating, editing or viewing a journal entry and viewing and editing infant information, such as weight and feeding information. The database 120 stores information needed by the application, such as articles, journal entries and infant information.

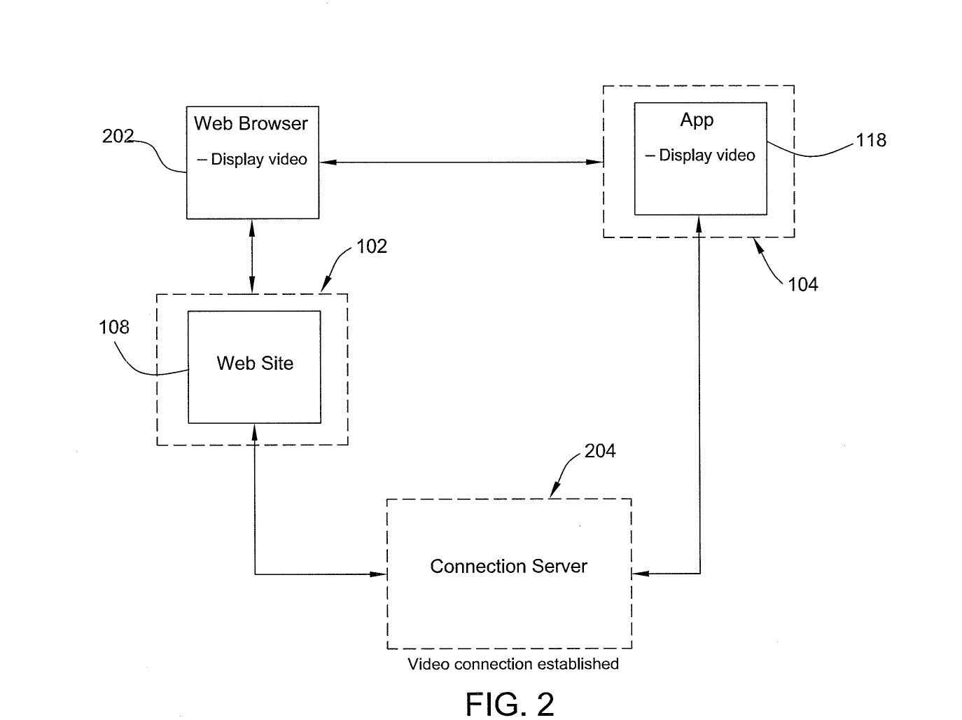

FIG. 2 is a diagram of a system for enabling video conferencing between a healthcare professional and a patient support person according to one embodiment. In one embodiment, a healthcare professional connects to the support management computer system 102 through a web browser 202. The support management computer system 102 and the support computing device 104 establish a video conference session. In some embodiments the session is established through a connection server 204. After a connection is established, the browser 202 and support computing device 104 enable a video conference. In some embodiments the app 118 displays the video conference session. In alternative embodiments, other applications are automatically launched or manually started to facilitate the video conference.

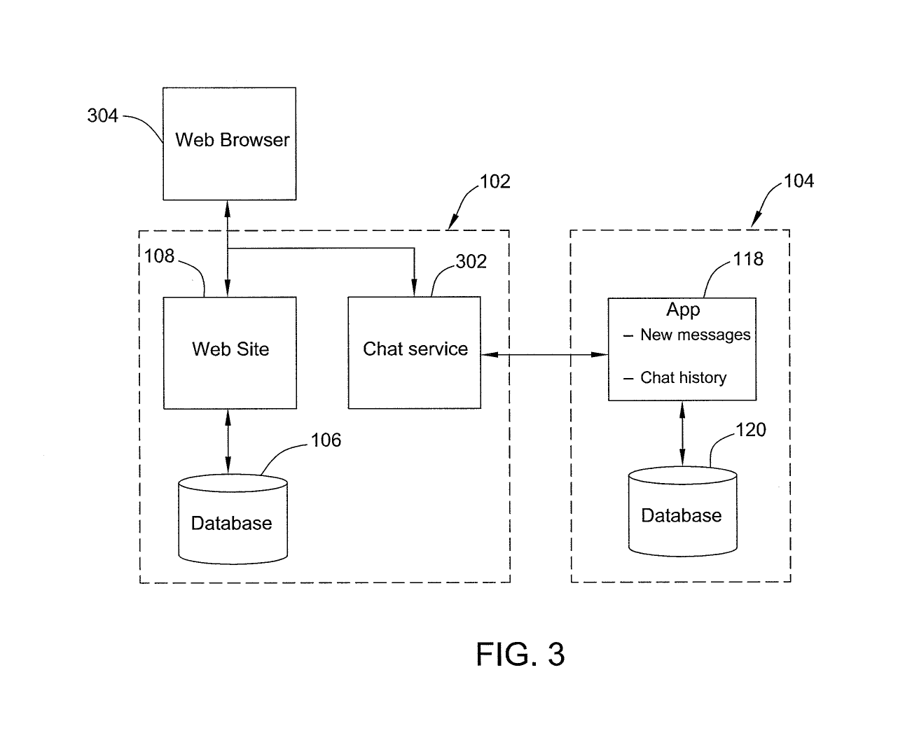

FIG. 3 is a diagram of a system for enabling text chatting between a healthcare professional and a patient support person according to one embodiment. Either the healthcare professional or the patient support person can initiate the text chat. In one embodiment, the healthcare professional uses a web browser 304 to connect to the support management computer system 102. The support management computer system 102 includes a chat service 302. It should be noted that the support management computer system 102 comprises one or more computers or servers. The chat service 302 and other services can reside on a single computer or on different computers making up the support management computer system 102. The chat service 302 establishes a connection between the browser 304 and the application 118 on the support computing device 104. Using the application 118, a support person can view new messages and a chat history stored in database 120.

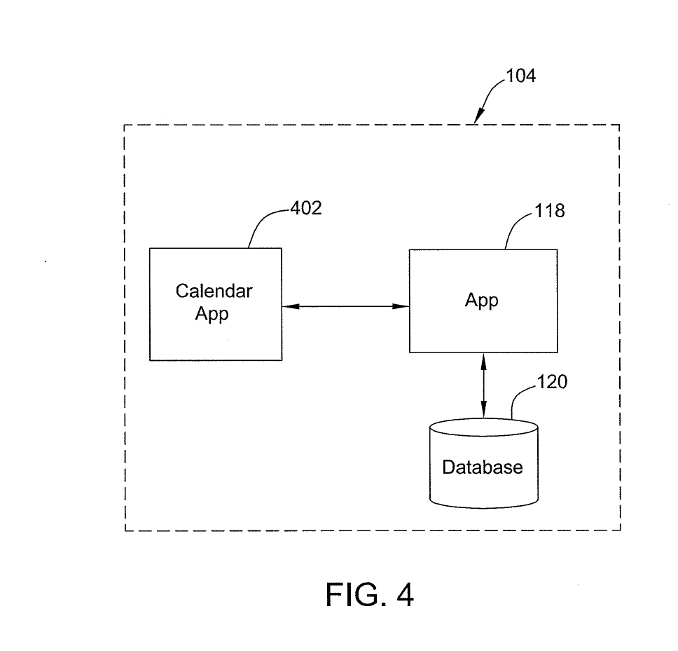

FIG. 4 is a diagram of a system for enabling a calendar on a support computing device according to one embodiment. In one embodiment, the application 118 interfaces with an external calendar application 402, such the native calendar application on a tablet computer. In this way, a healthcare professional can send appointments and other calendar entries from the support management computer system 102 to the support person's calendar on the support computing device 104. In some embodiments, the support computing device 104 is owned by the support person and contains their primary personal and/or work calendar. In this embodiment, the application 118 can interface with the support person's primary calendar, such as calendar 402.

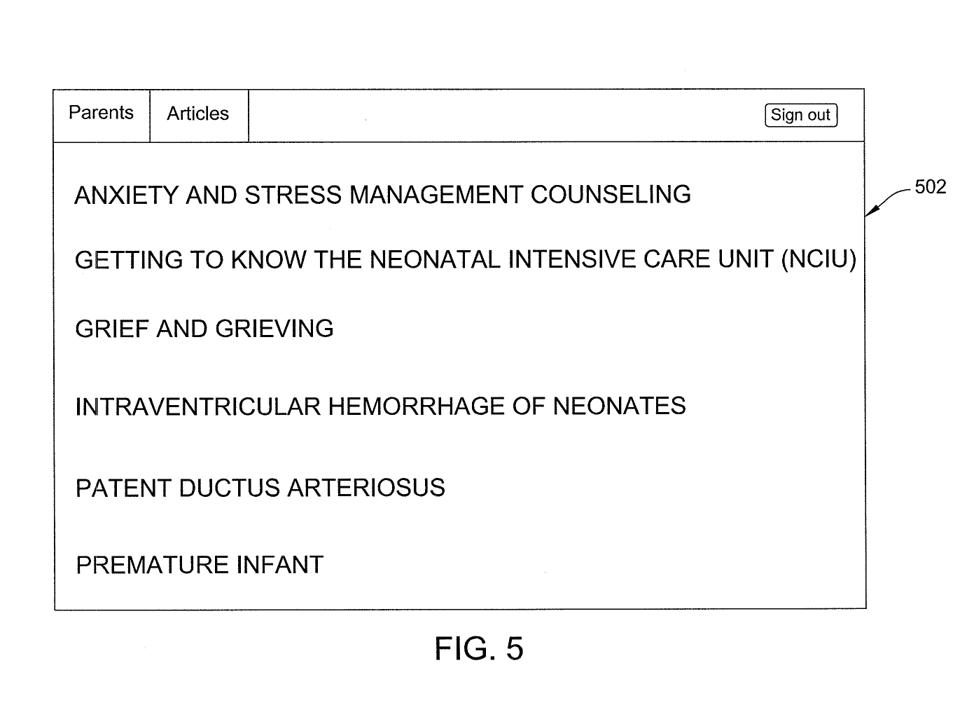

A user interface screen for managing material for a patient support person according to one embodiment is shown in FIG. 5. In one embodiment, a healthcare professional, such as a nurse, counselor or doctor can login to the support management computer system 102 using a web browser on a computer, tablet computer or mobile device. In alternative embodiments, the healthcare professional can use an application to access the support management computer system 102. FIG. 5 illustrates a webpage 502 showing a list of articles that can be transmitted to a support computing device 104 for review by a support person. In the illustrated embodiment, articles relevant to a parent with an infant in the NICU are shown. However, the disclosure applies to other types of patients and support persons. After the healthcare professional selects an article to transmit to a support person, the support person can view the article on their support computing device 104. The healthcare professional can then optionally track whether the support person has viewed the article by, for example, receiving an indication of whether the support person viewed the article or seeing a percentage associated with how far the support person scrolled through the article. In some embodiments, the support management computer system 102 can automatically select material for the support person to review. Whether the material is selected by a healthcare professional or automatically selected, the support management computer system 102 generates a personalized support program including educational material and support messages for the support person. This material can be updated over time and a new or revised personalized support program can be created based on a variety of factors including changes in the patient's condition and care data received by the support person.

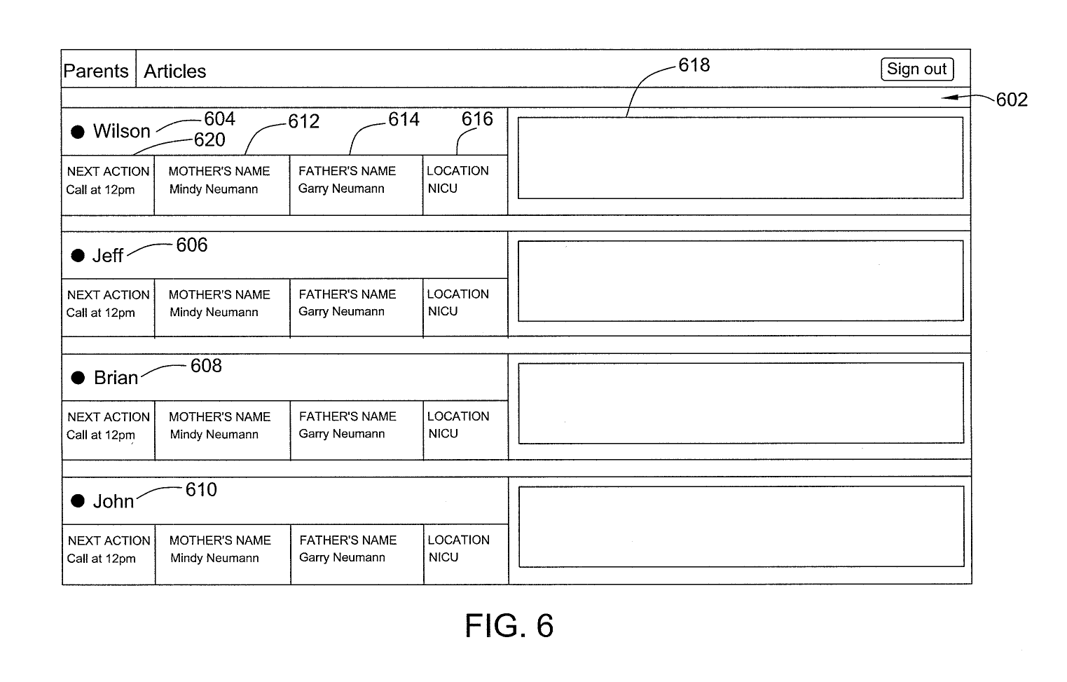

FIG. 6 illustrates a user interface screen for managing support people for a patient according to one embodiment. A healthcare professional logs into the support management computer system 102 and can associate support people with a particular patient. For example, in the illustrated embodiment the screen 602 shows four patients, Wilson 604, Jeff, 606, Brian 608 and John 610. Each patient has a next action 620 associated with them, such as a meeting, telephone call, text chat, video conference, or procedure. As shown in column 612, each patient has a first support person associated with them. In this embodiment each of the four patients are quintuplets with their mother as a first support person. In column 614 a second support person is associated with each patient. In this embodiment the second support person is the patients' father. Column 616 shows the location of each patient. In this case, all of the patients are in the NICU. Finally, column 618 will display any notes or other information associated with each patient.

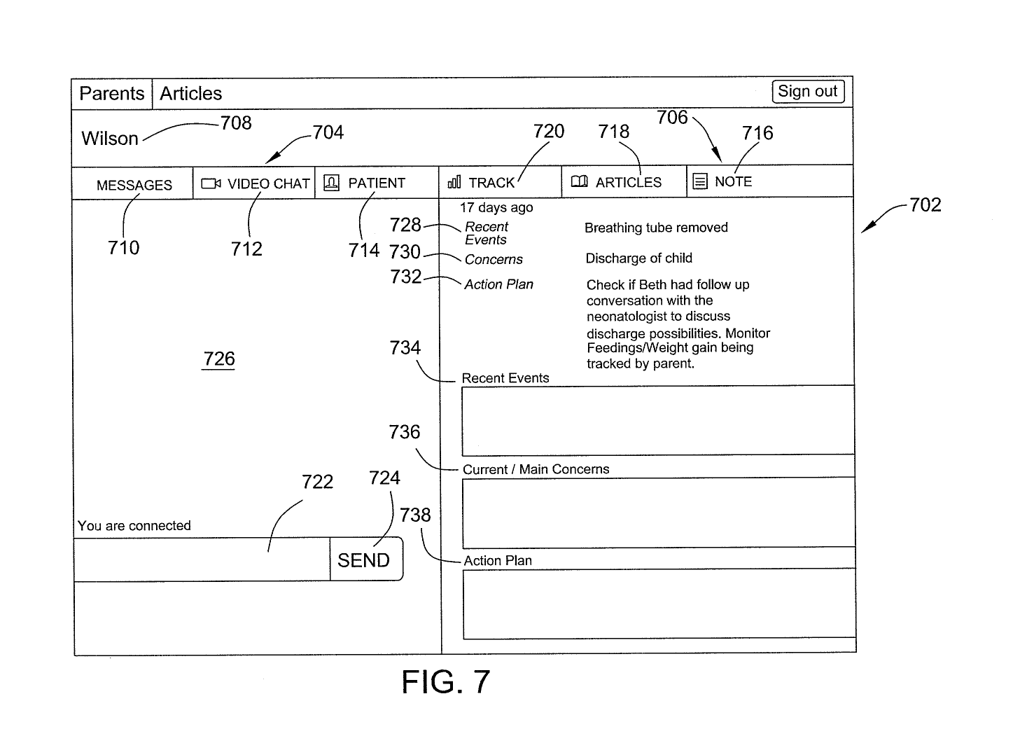

A user interface screen for performing a text chat with a patient support person according to one embodiment is illustrated in FIG. 7. The screen 702 is associated with a particular patient 708. In one embodiment, two selectable panels are available. Panel 704 shows a text chat session view with a support person. This view is selected by choosing the messages 710 view. Alternatively, video chat 712 and patient 714 can be chosen. Panel 706 shows a notes view for the patient. This view is selected by choosing notes 716. Alternatively articles 718 or track 702 can be chosen. Alternative embodiments include one or more panels. For example, in some embodiments, message view 702 fills the entire screen 702. The messages view 710 allows a healthcare professional to text chat with a support person by typing messages into entry area 722 and pressing send 724. Messages to and from the support person appear in area 726. In one embodiment, the text chat uses the system illustrated in FIG. 3.

Notes view 716 shows recent events 728, concerns 730 and an action plan 732 for the patient. In this way, the healthcare professional can view information about the patient that may be relevant to the text chat with the support person. Additionally, the healthcare professional can add recent events in box 734, concerns in box 736 and steps to the action plan in box 738.

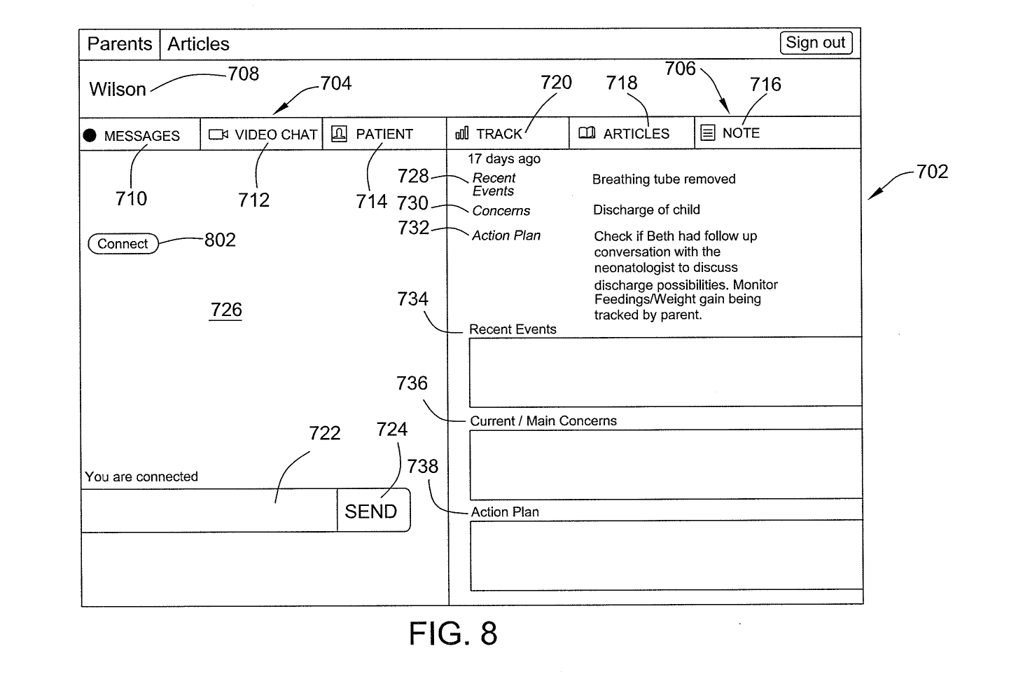

FIG. 8 illustrates a user interface screen for performing a video conference with a patient support person according to one embodiment. In interface 702, video chat 712 is selected in panel 704. The healthcare professional can initiate a video conference using the connection button 802. Alternatively, the support person can initiate a video chat on the support computing device 104. In one embodiment, the video conference uses the system illustrated in FIG. 2.

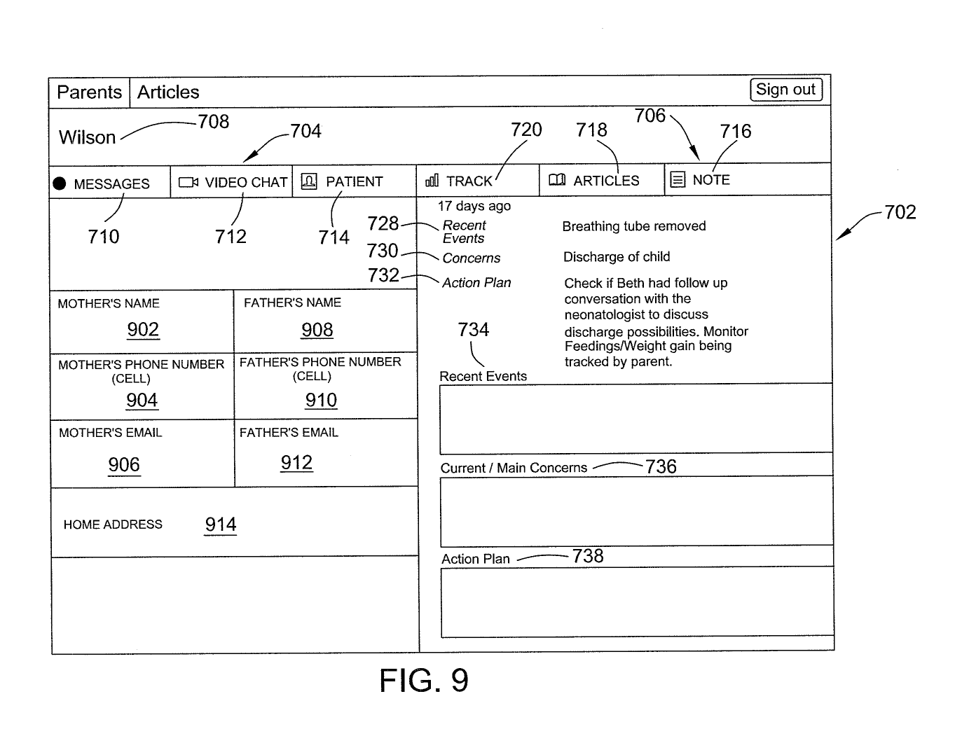

FIG. 9 illustrates a user interface screen for entering patient information according to one embodiment. The patient view 714 is selected in the panel 704. In this embodiment, the patient 708 is an infant in the NICU. Information related to the patient in this embodiment includes the mother's name 902, mother's phone number 904, mother's email 906, father's name 908, father's phone number 910, father's email 912 and the patient's address 914. In this embodiment the mother and father are both members of the patient's support group. In alternative embodiments, contact information for additional or different support members can be added.

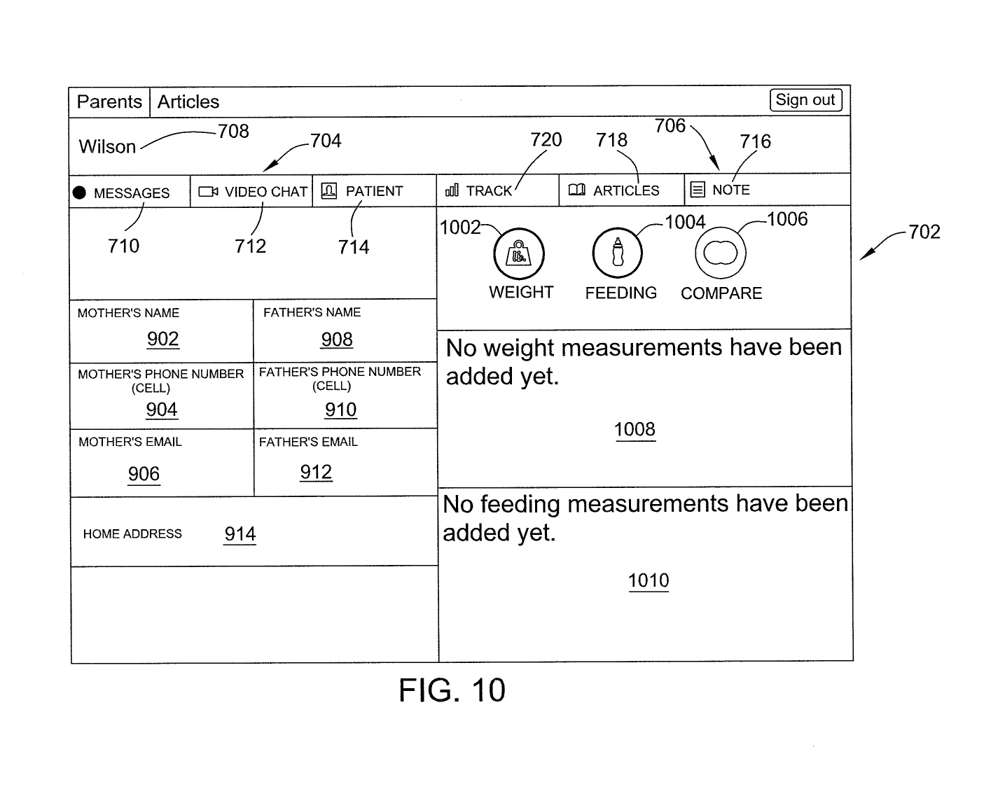

FIG. 10 illustrates a user interface screen including patient information and patient tracking information according to one embodiment. The patient information view 714 is selected in panel 704. However, in this screen, the track view 720 is selected in panel 706. The track screen allows a healthcare professional to select weight 1002, feeding 1004 or compare 1006 for display. In the illustrated embodiment compare 1006 is selected and any weight measurements appear in area 1008 and feeding measurements appear in area 1010. The weight and feeding measurements can appear as a list of data points, in graphical form or a combination.

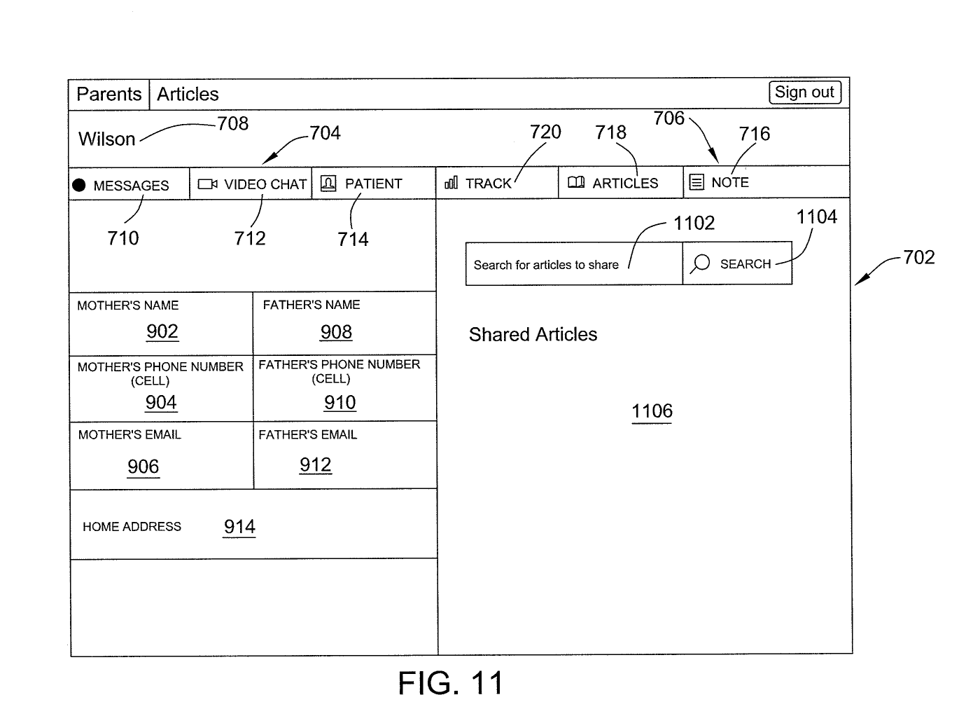

A user interface screen for managing material for a patient support person according to one embodiment is illustrated in FIG. 11. The patient information view 714 is selected in panel 704. However, in this screen, the articles view 718 is selected in panel 706. The articles view 718 allows a healthcare professional to search for, view and share articles or other material with a support person. Search box 1102 allows a healthcare professional to enter text and search that text by pressing the search button 1104. A list of relevant articles will appear in article area 1106. If a search is not being performed, article area 1106 displays a list of articles or other material, videos, audio clips and educational resources shared with a support person. In some embodiments, the healthcare professional can see whether a support person has viewed an article or other material in this view.

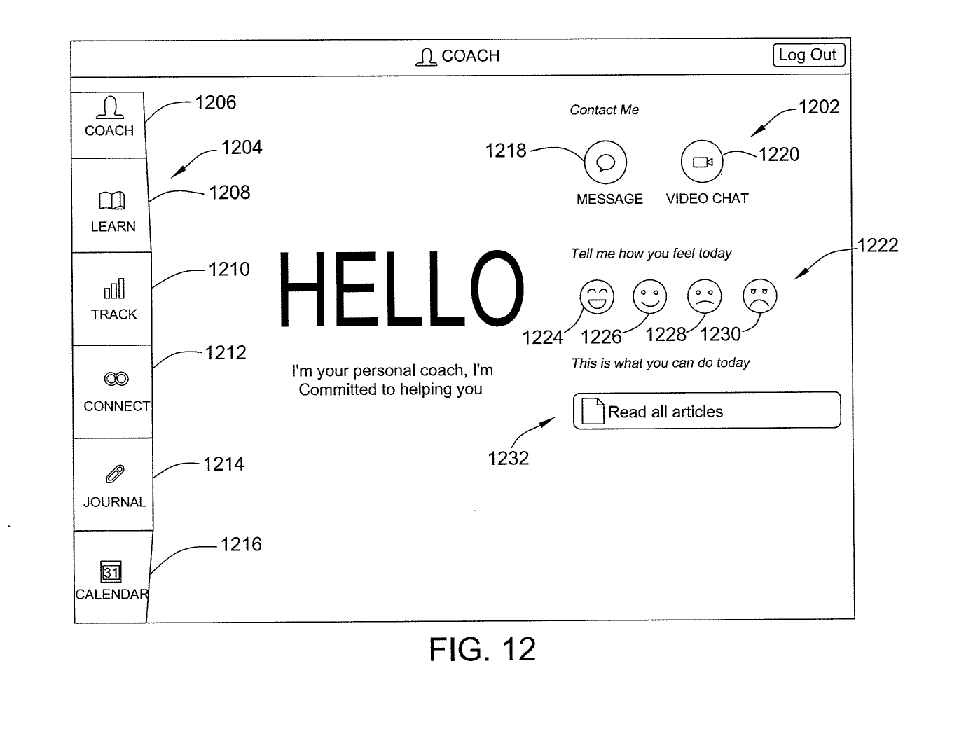

A user interface screen for navigating a support computing device according to one embodiment is shown in FIG. 12. Screen 1202 illustrates one embodiment of a main navigation page for the support computing device. As discussed, the support computing device can be a desktop computer, laptop computer, tablet computer or mobile device such as a mobile telephone. The device can be a dedicated support computing device or can be configured as a multi-purpose device with one or more applications. In the illustrated embodiment, the support computing device is a tablet computing with an application for implementing the support functionality. Navigation panel 1204 allows a support person to navigate to the various sections of the application. Coach 1206, learn 1208, track 1210 connect 1212, journal 1214 and calendar 1216 allow a user to navigate to each of the respective sections of the application. Each of these sections will be discussed in more detail below. The navigation bar 1204 can be accessed from anywhere within the application.

Screen 1202 illustrates the coach section of the application. The coach section of the application facilitates communication with a healthcare professional. A support person can launch a text chat using the message button 1218 or a video chat using the video chat button 1220. In one embodiment, this will connect the support person to the healthcare professional using the systems of FIGS. 1-3. Quick journal section 1222 allows a support person to quickly indicate how they feel, mentally, physically or both, based on a four level scale by pressing one of buttons 1224, 1226, 1228 or 1230. Section 1232 provides quick access to daily activities, such as articles that be read in the learning section.

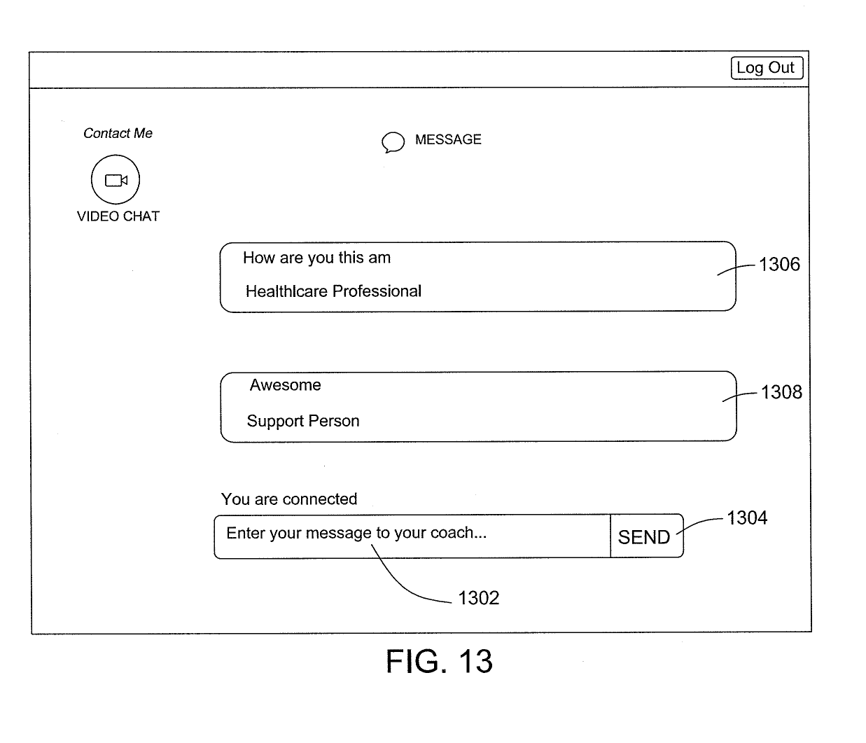

FIG. 13 illustrates a user interface screen for performing a text chat, on a support computing device, with a healthcare professional according to one embodiment. In one embodiment, a support person pressing the message button 1218 on the coach interface 1202 accesses this section. New messages are entered in box 1302 and sent by pressing send button 1304. The text conversation can then be read on the screen. For example, box 1306 shows a message from a healthcare professional and box 1308 shows a message from the support person. In one embodiments, the messages continue appearing on the screen and can be scrolled through.

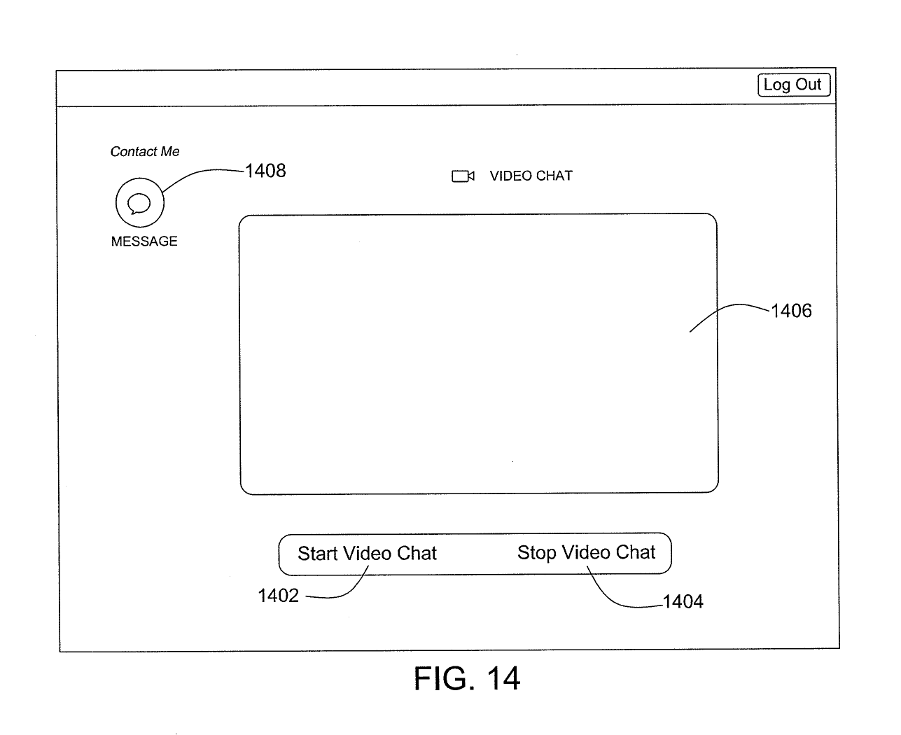

FIG. 14 illustrates a user interface screen for performing a video conference, on a support computing device, with a healthcare professional according to one embodiment. A video conference is started by pressing button 1402. The video conference is ended by pressing button 1404 The conference participant video appears in window 1406. In one embodiment, the video chat functionality is implemented using the system described in FIG. 2.

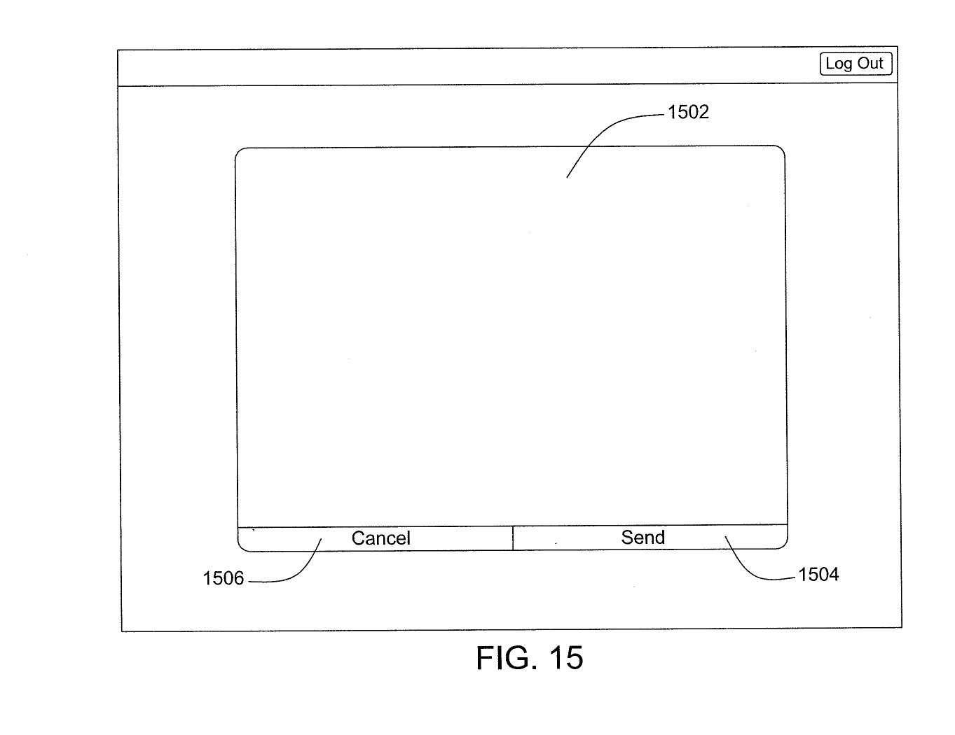

A user interface screen for sending electronic mail, on a support computing device, to a healthcare professional according to one embodiment is shown in FIG. 15. In one embodiment, this screen can be accessed from anywhere in the app. A new message can be typed in box 1502. The message can be sent by pressing send button 1504 or cancelled by pressing button 1506.

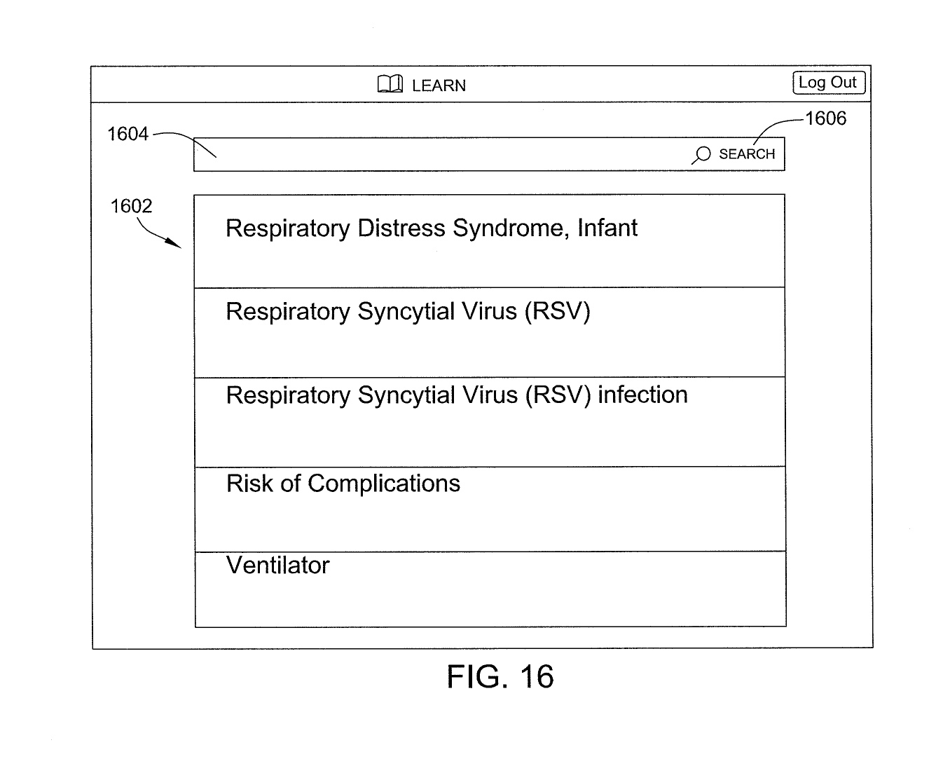

FIG. 16 illustrates a user interface screen for reviewing material on a support computing device according to one embodiment. The screen 1602 shows a list of articles or other material, videos, audio clips and educational resources shared with the support person. The support person can search for material by entering text in box 1604 and pressing search 1606. The material may help the support person care for or understand the patient's condition. Additionally, the material may help the support person with their own issues, such as emotional issues, resulting from supporting the patient. The material can be sent to the support computing device 104 by the healthcare professional or can automatically be selected and sent to the support computing device by the support management computer system 102. The material can be selected based on the goals and care needs identified during the initial intake process. The material can further be selected based on changed condition of the patient, updated journal entries, including information related to the emotional condition of the support person, and updated care data for the patient.

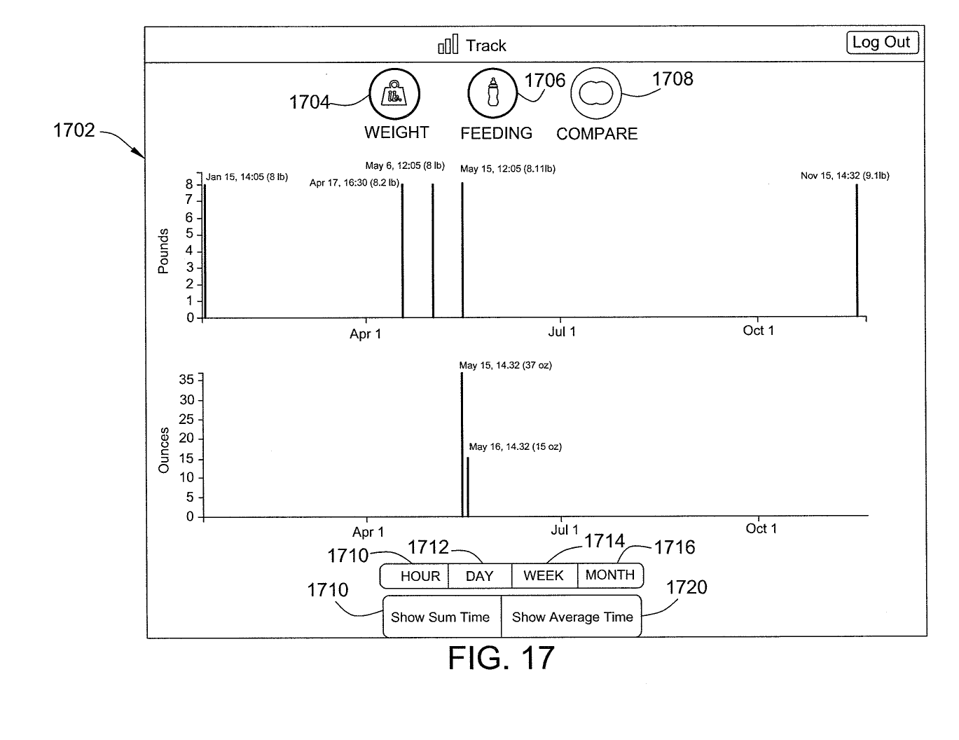

FIG. 17 illustrates a user interface screen for viewing patient tracking information on a support computing device according to one embodiment. The tracking screen 1702 includes a view for the patient's weight, which can be accessed by pressing button 1704, patient feedings, which can be accessed by pressing button 1706 and a compare view, which can be accessed by pressing button 1708. However, in alternative embodiments, additional or different patient tracking data can also be viewed. The data can be viewed by hour 1710, day 1712, week 1714 or month 1716. The time can be displayed as a sum 1718 or average 1720. It should be noted that other time scales could be used. Screen 1702 shows a comparison of weight and feedings in a day view with sum time.

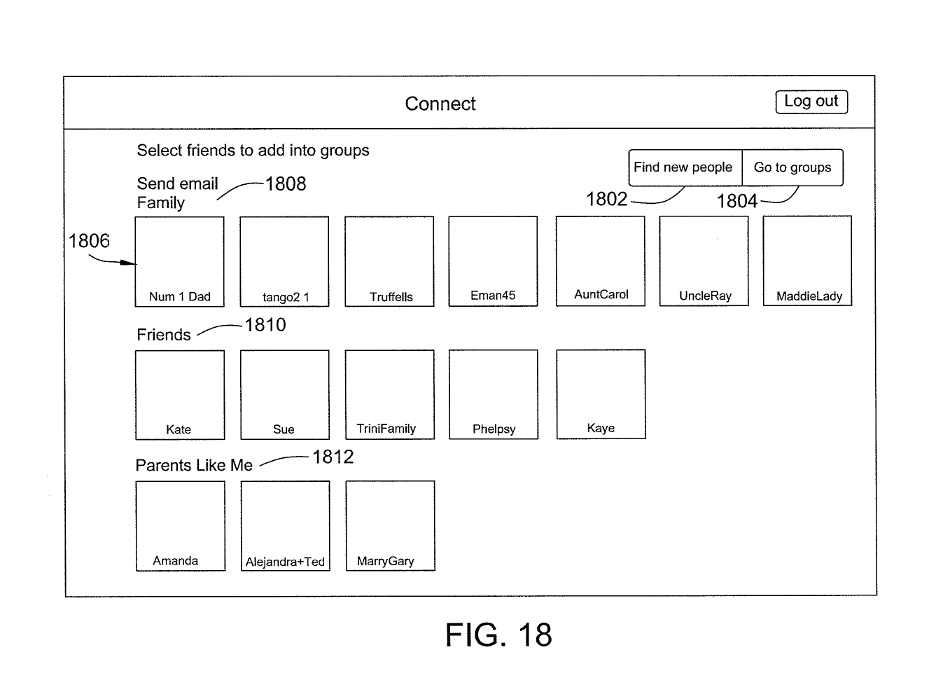

FIG. 18 illustrates a user interface screen for connecting with a support community on a support computing device according to one embodiment. A support person can search for new people by pressing button 1802. The search can be based on name, user name, or attributes, such as the patient condition, age, or other data. The groups button 1804 displays the groups page 1806. In the illustrated embodiment, there are groups for family 1808, friends 1810, and parents like me 1812. The family and friends information can be populated by searching for or entering details for a support person's family and friends. In one embodiment, the support person a parent with an infant in the NICU. A healthcare professional can manually match similar parents in the parents like me section 1812 to provide a support group for the support person. In another embodiment, the support management computer system 102 automatically selects parents like me based on, for example, patient condition, journal entries, including information related to the emotional condition of the support person, and updated care data for the patient. The support person can then email one or more of the people or groups by selecting either the group title (i.e., parents like me 1812) or an individual within one of the groups. In alternative embodiments, the support person can text message and or video chat with one or more of the people or groups.

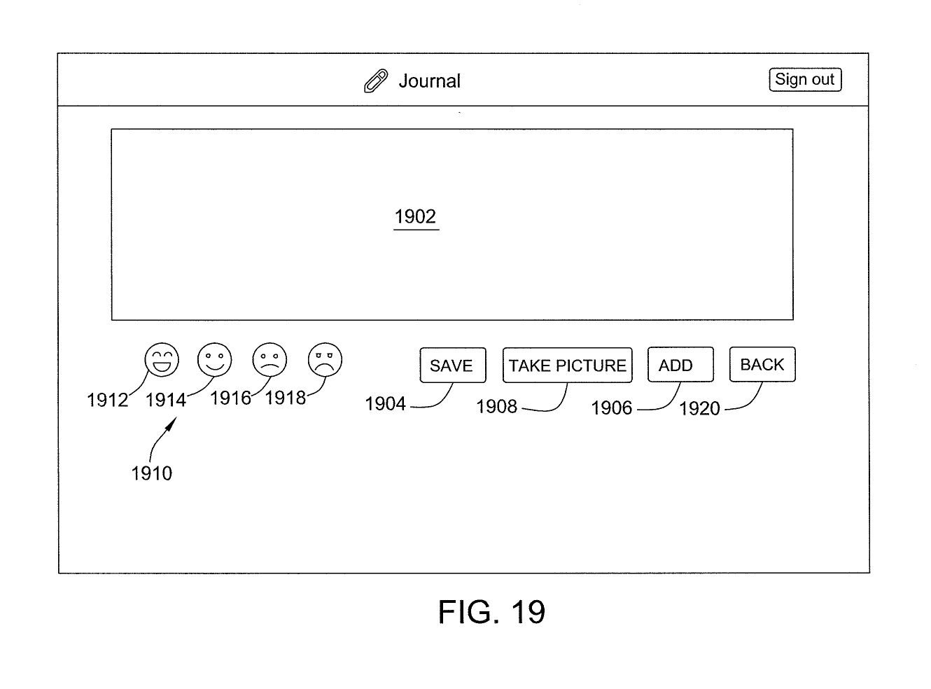

FIG. 19 illustrates a user interface screen for entering journal information on a support computing device according to one embodiment. A support person can enter text in box 1902. The text can be saved 1904 and added to the journal 1906. Additionally, the support person can take a picture with the support computing device 104 by pressing button 1908. The picture then becomes part of the journal. The journal text can include information relating to the patient or to the support person. In one example, the support person enters text relating to a skin condition of the patient and can then take a picture of the condition using button 1908 to include in the journal. Quick journal section 1910 allows a support person to quickly indicate how they feel, mentally, physically or both, based on a four level scale by pressing one of buttons 1912, 1914, 1916 or 1918. Additionally, the support person can navigate back in the application by pressing back button 1920.

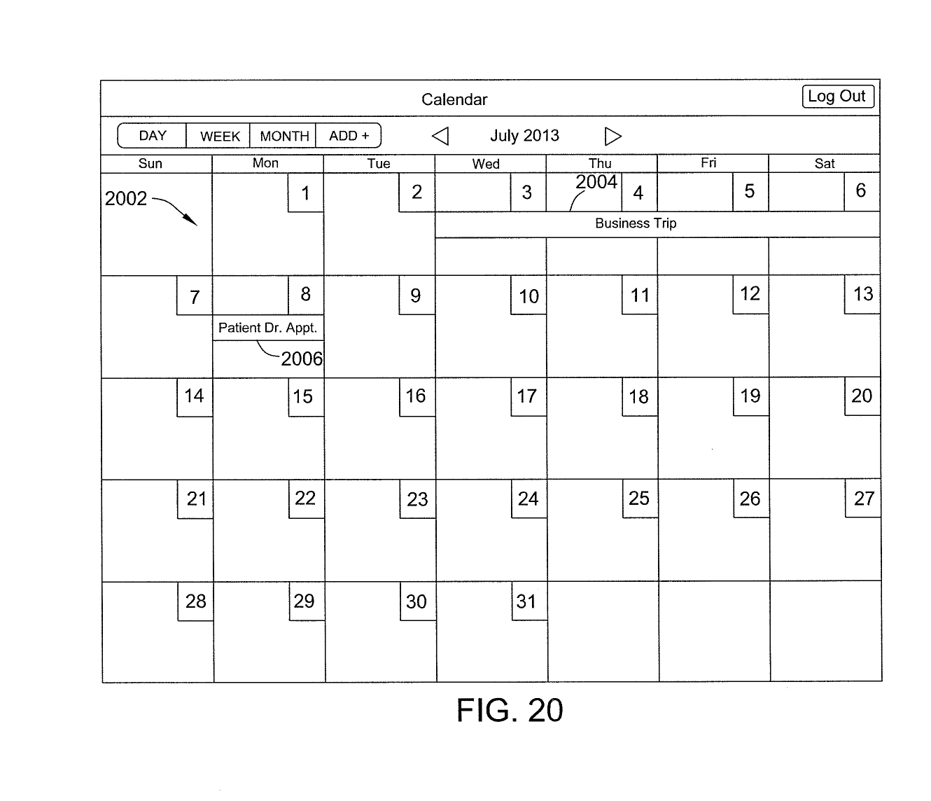

FIG. 20 illustrates a user interface screen for reviewing material on a support computing device according to one embodiment. In one embodiment, the calendar 2002 integrates with an external calendar on the support computing device 104, such the native calendar application on a tablet computer. In this way, a support person's calendar on the support computing device 104 can integrate with appointments made through the support management computer system 102. In some embodiments, the support computing device 104 is owned by the support person and contains their primary personal and/or work calendar. In the illustrated embodiment, the support person has a business trip 2004 on the calendar and a patient doctor appointment.

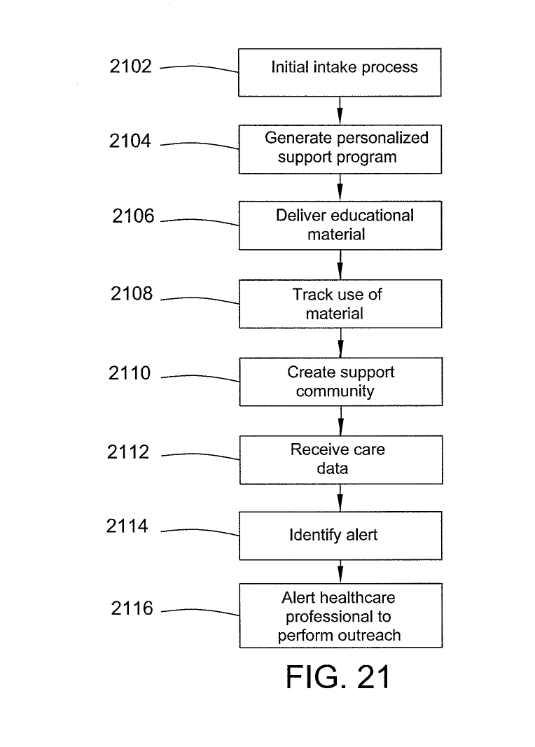

FIG. 21 is a flow chart illustrating a method for supporting the care of a patient in accordance with one embodiment. As shown, the method begins at step 2102. A patient's care needs and goals for the support person are identified by conducting an initial intake process. The intake process can be automated by, for example, having the support management computer system 102 prompt the patient, the support person or both to answer a series of questions relating to care needs and goals. In another embodiment, the intake process is completed by having a healthcare professional interview the patient, the support person or both relating to care needs and goals. At step 2104, the support management computer system 102 generates a personalized support program for the patient. The support program is based on the identified care needs of the patient and goals for the support person. The personalized support program may include a variety of material such as educational material, support messages, articles or other material, videos, audio clips for the support person.

At step 2106, the support management computer system 102 delivers the personalized support program to the support person via a network connected support computing device 104. At step 2108 the support management computer system 102 tracks whether the support person completes the goals and views the educational material on the support computing device. The goals can include weighing the patient daily, logging feedings for the patient, or any other items relating to the patient or support person.

At step 2110, a support community is created. The support community may be created based on similarly situated individuals to the support person The support community is then accessible via the support computing device. In one embodiment, the community is created automatically by the support management computer system 102. In an alternative embodiment, the healthcare professional creates the community. At step 2112, the support management computer system 102 receives care data related to the patient from the support person. The care data includes information relating to the medical condition of the patient. For example, care data relating to an infant may include weight and feedings. At step 2114, the support management computer system 102 processes the care data to identify at least one care management trigger. For example, in one embodiment, if a patient is losing weight, an alert may be triggered. At step 2116, the support management computer system 102 alerts the healthcare professional to perform an outreach based on the care management trigger. The outreach may be to the support person or to the patient.

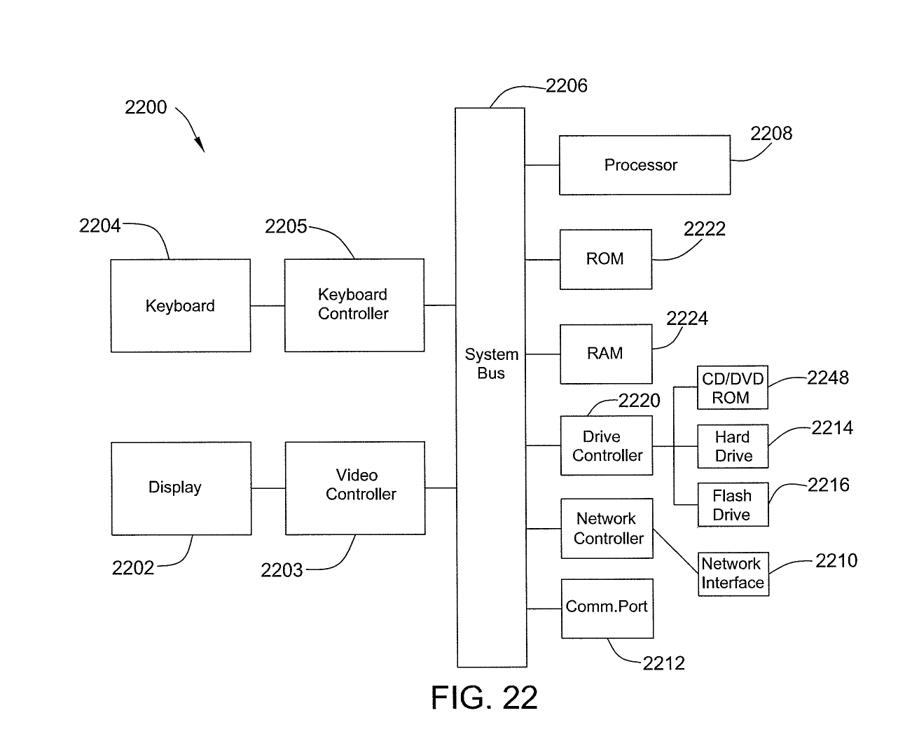

FIG. 22 is a schematic diagram showing hardware components of a support management computer system according to one embodiment. Those skilled in the art will realize that the support management computer system 102 may include one or more computing devices described herein. The computing device 2200, such as a computer, including a dedicated special-purpose support management device, includes a plurality of hardware elements, including a display 2202 and a video controller 2203 for presenting to the user an interface for interacting with the system. The computing device 2200 further includes a keyboard 2204 and keyboard controller 2205 for relaying the user input via the user interface. Alternatively or in addition, the computing device 2200 includes a tactile input interface, such as a touch screen. The display 2202 and keyboard 2204 (and/or touch screen) peripherals connect to the system bus 2206. A processor 2208, such as a central processing unit (CPU) of the computing device or a dedicated special-purpose support management processor, executes computer executable instructions comprising embodiments of the support management system, as described above. In embodiments, the computer executable instructions are received over a network interface 2210 (or communications port 2212) or are locally stored and accessed from a non-transitory computer readable medium, such as a hard drive 2214, flash (solid state) memory drive 2216, or CD/DVD ROM drive 2218. The computer readable media 2214-2218 are accessible via the drive controller 2220. Read Only Memory (ROM) 2222 includes computer executable instructions for initializing the processor 2208, while the Random Access Memory (RAM) 2224 is the main memory for loading and processing instructions executed by the processor 2208. In some embodiments, as described above, a healthcare professional interacts with the support management computer system 102 using another computing device, such as a desktop computer, laptop computer, tablet computer or mobile device such as a mobile telephone. The healthcare professional can interact with the support management computer system using an application, webpage, virtual desktop environment or other access means.

The support computing device 104 may have a similar structure to the support management computing system, including a processor or a dedicated special-purpose support processor, which executes computer executable instructions comprising embodiments of the support management system, as described above.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for supporting the care of a prematurely born infant, the infant having a support network with at least one parent in the support network, the method comprising:
identifying the infant's care needs and goals for the parent by conducting an initial intake process with the parent;
generating, by a support management processor, a personalized support program for the infant based on the identified care needs and goals for the parent wherein the personalized support program includes educational material for the parent;
delivering, by the support management processor, the educational material to the parent via a network connected support computing device;
tracking, by the support management processor, whether the parent completes the goals, views the educational material on the support computing device;
creating, by the support management processor, a support community, wherein the support community is accessible via the support computing device;
receiving, at the support management processor, care data related to the infant from the parent;
processing, by the support management processor, the care data to identify at least one care management trigger; and
alerting, by the support management processor and based on the care management trigger, a healthcare professional to perform an outreach to the parent.

2. The method of claim 1 further comprising identifying, by the support management processor, a change in the mental state of the parent using the received data.

3. The method of claim 1 further comprising establishing a text chat session between the healthcare professional and the parent.

4. The method of claim 1 further comprising establishing a video conferencing session between the healthcare professional and the parent.

5. The method of claim 1 wherein the care data includes one of the infant weight triggers, infant feeding triggers and parent emotional status triggers.

6. The method of claim 1 wherein the infant is in a neonatal intensive care unit.

7. The method of claim 1 wherein the infant is an outpatient.

8. A method for supporting the care of a patient, the patient having a support network with at least one support person in the support network, the method comprising:
identifying the patient's care needs and goals for the support person by conducting an initial intake process;
generating, by a support management processor, a personalized support program for the patient based on the identified care needs and goals for the support person, wherein the personalized support program includes educational material for the support person;
delivering, by the support management processor, the educational material to the support person via a network connected support computing device;
tracking, by the support management processor, whether the support person completes the goals, views the educational material on the support computing device;
creating, by the support management processor, a support community, wherein the support community is accessible via the support computing device;
receiving, at the support management processor, care data related to the patient from the support person;
processing, by the support management processor, the care data to identify at least one care management trigger; and
alerting, by the support management processor and based on the care management trigger, a healthcare professional to perform an outreach to the support person.

9. The method of claim 8 further comprising identifying, by the support management processor, a change in the mental state of the support person using the received data.

10. The method of claim 8 further comprising establishing a text chat session between the healthcare professional and the support person.

11. The method of claim 8 further comprising establishing a video conferencing session between the healthcare professional and the support person.

12. The method of claim 8 wherein the care data includes one of patient weight triggers, patient feeding triggers and support person emotional status triggers.

13. The method of claim 8 wherein the patient is an infant in a neonatal intensive care unit.

14. The method of claim 13 where the support person is a parent of the infant in the neonatal intensive care unit.

15. A non-transitory computer readable medium having stored thereon computer executable instructions for supporting the care of a patient, the patient having a support network with at least one support person in the support network, the instructions comprising:
generating a personalized support program for the patient based on identified care needs and goals for the support person, wherein the personalized support program includes educational material for the support person;
delivering the educational material to the support person via a network connected support computing device;
tracking whether the support person completes the goals, views the educational material on the support computing device;
creating a support community, wherein the support community is accessible via the support computing device;
receiving care data related to the patient from the support person;
processing the care data to identify at least one care management trigger; and
alerting, based on the care management trigger, a healthcare professional to perform an outreach to the support person.

16. The computer readable medium of claim 15 further comprising instructions for identifying a change in the mental state of the support person using the received data.

17. The computer readable medium of claim 15 further comprising instructions for establishing a text chat session between the healthcare professional and the support person.

18. The computer readable medium of claim 15 further comprising instructions for establishing a video conferencing session between the healthcare professional and the support person.

19. The computer readable medium of claim 15 wherein the care data includes one of patient weight triggers, patient feeding triggers and support person emotional status triggers.

20. The computer readable medium of claim 15 further comprising instructions for receiving journal entries from the support person.
